(19) United States
(12) Patent Application Publication
(10) Pub. No.: US 2010/0106562 A1
(43) Pub. Date: Apr. 29, 2010

(54) USER-TARGETED CONTENT PROCESSING SYSTEM AND METHOD

(75) Inventors: John Richard Taylor, Tiburon, CA (US); Randy Yen-pang Chou, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Pixel8 Networks, Inc., Menlo Park, CA (US)

(21) Appl. No.: 12/259,958

(22) Filed: Oct. 28, 2008

(51) Int. Cl. G06Q 30/00; G06F 15/16

(52) U.S. Cl. 705/10; 709/206; 705/14.55

(57) ABSTRACT

According to one embodiment of the invention, a method is devised for tailoring downloaded content to the requesting user by upon receiving a message requesting content. The message includes information that provides information about a user requesting the content. Before receipt by the requesting user, the content is modified by inserting user-targeted information directly within the content. The user-targeted information is retrieved using the information. Thereafter, the modified content is transmitted to a device controlled by the requesting user.

### FIELD

Embodiments of the invention generally relate to a system and method for integrating user-targeted information, such as one or more advertisements and/or watermarks, within content to be downloaded to a client device.

### GENERAL BACKGROUND

The Internet is a decentralized public network of electronic devices that are communicatively connected together on a global scale. A message can be sent from any electronic device on the Internet to any other electronic device simply by specifying a targeted destination address for the message at transmission. The message will likely experience a series of intermediary devices, such as bridges and routers for example, which will receive the message in transit, determine the intended destination of the message, and continue routing the message to its intended destination.

The popularity and use of the Internet continues to increase at a rapid rate. Since the introduction of the World Wide Web, referred to as the “Web,” most Internet users are provided with a graphical user interface (GUI) to the Internet, which allows the users to access Web pages stored on servers located worldwide. These “Web pages” feature text and graphics and are generally described, in terms of layout and content, by way of a programming language known as HyperText Markup Language (HTML).

A software program, known as a “browser,” is executed at an electronic device controlled by the user (referred to as a “client device”) and enables the user to control the access and viewing of these Web pages by either (i) specifying the location, namely the targeted Internet address of the desired Web page, or (ii) “linking” to Web pages. The desired Web page is specified by a uniform resource locator (URL), which indicates the precise location of the HTML file. “Linking,” however, is accomplished by the desired Web page containing, in addition to textual and visual data specified in HTML format, embedded information referred to as “links” in the form of URLs that point to Internet addresses of other Web pages. These other Web pages are often maintained on other electronic devices throughout the Internet.

The user, by selecting a link or an image embedded with a link (often by selecting the link or image with an input device), accesses content within other Web pages, which can in turn contain further data and/or additional links. When a Web page is accessed, its information is transmitted across the Internet to the client device accessed by the user.

Over the last few years, more and more data centers have emerged for hosting multimedia content, such as video files, for public viewing. In order to generate revenue for hosting the multimedia content, advertisements are not only displayed on the website(s) associated with the data center(s), but also are transmitted along with the downloaded video for playback. However, with the growing sophistication and presence of ad blocking software, many data centers are only able to realize revenue associated with the advertisements presented at the web site. This is due to the fact that the ad blocking software is filtering the downloaded advertisements sent along with the video, and thus, the advertisements are not being viewed by the users. This substantially decreases the profitability of the data centers, which tends to translate into lesser overall services being freely offered to the public at large by these data centers.

### BRIEF DESCRIPTION OF THE DRAWINGS

Features and advantages of embodiments of the invention will become apparent from the following detailed description in which:

FIG. 1A and 1B are exemplary embodiments of an user-targeted data processing system deployed between one or more data servers and a client device.

FIG. 2 is a block diagram of an exemplary embodiment of the user-targeted data processing system of FIGS. 1A and 1B.

FIG. 3 is an exemplary embodiment of an HTTP Request message with the cookie header and optional attribute parameters placed as values of the User-Agent Header within the HTTP Request message.

FIG. 4 is an exemplary embodiment of the communications between the data center and a client device requesting content from the data center.

FIG. 5 is an exemplary embodiment of a flowchart that outlines operations performed by the user-targeted data processing system of FIG. 2 to integrate user-specific information into requested content and subsequently store attribute parameters of a client device for such integration.

FIG. 6 is an exemplary embodiment of a flowchart that outlines operations performed by the user-targeted data processing system of FIG. 2 to insert a watermark into the content.

### DETAILED DESCRIPTION

Embodiments of the invention set forth in the following detailed description generally relate to a method, system and software for inserting user-targeted information into retrieved content. This “user-targeted information” may be (i) one or more advertisements targeted for the intended user, and/or (ii) information that identifies the intended user (referred to as a “watermark”). As an example of one embodiment of the invention, content is requested by transmission of a Request message for such content by a device. Examples of a “Request message” include, but are not limited or restricted a Hypertext Transfer Protocol (HTTP) Request message or a Real Time Streaming Protocol (RTSP) Request message. The Request message includes user-specific information that is used to select or formulate the user-targeted information that is subsequently inserted within the content requested by the user of the device.

As described below, in one embodiment of the invention, the system is implemented at the data center hosting one or more data servers. Of course, it is contemplated that the system may be positioned remotely from the data center and along the communication path to/from the data center. This system is adapted to (i) intercept incoming Request messages for content from a device, (ii) perform operations on the downloaded content to place the content in its raw (decoded and decompressed) form, (iii) integrate the user-targeted information (e.g., advertisement and/or watermark) into the content thereby producing “user-specific content,” and (iv) re-format (encode and/or compress) the user-specific content for download to the device.

As an option, the Request message also may include attribute parameters, namely values that identify specific characteristics of the device that initiated the Request message. These attribute parameters may include, but are not limited or restricted to any of the following: display screen resolution of the device, compression type(s) supported by the device, operating system (OS) type, processor speed, or the like. These attribute parameters may be subsequently used to modify both characteristics of the downloaded content and the user-targeted information added thereto, compress this modified content according to a particular compression algorithm, or the like.

In the following description, certain terminology is used to describe certain features of the invention. For instance, both “logic” and “module” are general terms for hardware and/or software configured to perform one or more functions. One example of logic is a processing subsystem that is a collection of hardware and software featuring at least one processor (e.g., microprocessor, application specific integrated circuit, a digital signal processor, a micro-controller, field programmable gate array, etc.), finite state machine, combinatorial logic, or the like.

“Software” is generally describes as a series of executable instructions in the form of an application, an applet, or even a routine. The software may be stored as modules in any type of machine readable medium such as a programmable electronic circuit, a semiconductor memory device such as volatile memory (e.g., random access memory, etc.) and/or non-volatile memory such as any type of read-only memory “ROM”, flash memory, a portable storage medium (e.g., USB drive, optical disc, digital tape), or the like.

The term “message” represents information configured for transmission over a network. One type of message is a frame that is generally defined as a group of bits of information collectively operating as a single data unit. The term “content” includes video, audio, images or any combination thereof. “Advertisements” is a type of content and is generally defined as one or more static images, video, audio or any combination thereof that are designed to illustrate and/or describe goods and/or services available to the user.

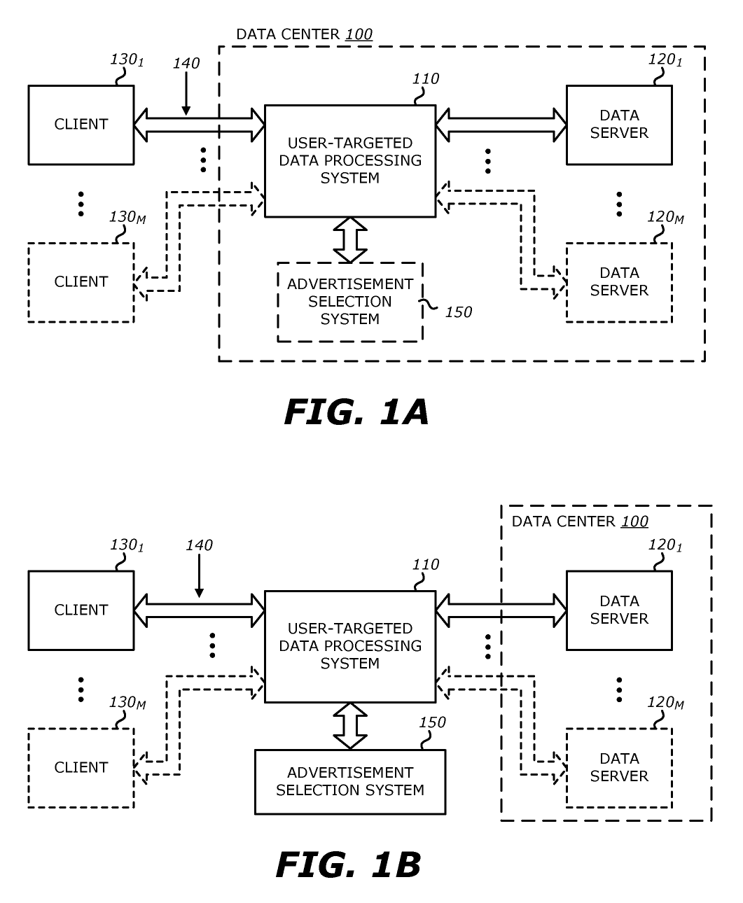

Referring to FIGS. 1A and 1B, exemplary embodiments of a data center 100 that support the downloading of content is shown. Data center 100 receives requests for content from one or more (N≧1) client devices 130₁-130_{N} and downloads the content in accordance with the attributes of the client device initiating the request (e.g., client device 130₁). The content is provided to client device 130₁ over a network interconnect 140, which is a medium that supports communications over a network such as a wide area network (e.g., Internet, cellular-based network) or a local area network (LAN). According to one embodiment of the invention, the medium may be a wired medium (e.g., twisted pair, fiber optic, etc.) or over a wireless medium.

As shown in FIG. 1A, data center 100 comprises (i) a user-targeted data processing system 110 in communication with both client devices 130₁-130_{N} and and (ii) one or more (M≧1) data servers 120₁-120_{M}. For instance, user-targeted data processing system 110 may be located adjacent to data servers 120₁-120_{M} in the same area designated for the servers. For FIG. 1B, however, user-targeted data processing system 110 is positioned remotely from data center 100, but along its transmission path to intercept messages from/to clients 120₁-120_{M}.

Of course, it is contemplated that user-targeted data processing system 110 may also be implemented outside the transmission path as an IP endpoint device. For this embodiment, however, user-targeted data processing system 110 would locate the data server 120₁, . . . and/or 120_{M} with the desired content by issuing a DNS (Domain Name System) Request for the server hostname. The DNS Response would contain the IP address of that data server. Thereafter, when client devices 130₁, . . . or 130_{N} issues the same DNS Request, the IP address of user-targeted data processing system 110 is returned.

User-targeted data processing system 110 receives information that identifies the user of a client device (e.g., client device 130₁) initiating a request for content. Upon receiving the requested content from data server(s) 120₁, . . . , and/or 120_{M}, user-targeted data processing system 110 modifies this content by integrating the advertisements received from an advertisement-selection system within the content itself. The advertisement-selection system may be implemented as a local database stored within user-targeted data processing system 110 (not shown), one or more local advertisement servers in communication with user-targeted data processing system 110 and contained within data center 100 (see FIG. 1A), or advertisement servers remotely located from data center 100 (see FIG. 1B).

As an illustrative example, client device 130₁ may be any electronic device including portable electronic devices such as a cellular phone with WiFi capability for example. One example of a cellular phone with WiFi capability is the Apple® iPhone™ with a screen resolution of 480×320. Upon detecting a Request message for content maintained by data center 100, such as a HTTP GET Request message or a RTSP Play message for a video file, user-targeted data processing system 110 extracts information within the Request message to identify the user of client device 130₁. Also, as an option, user-targeted data processing system 110 extracts information within the Request message to determine a few core attributes of client device 130₁. Thereafter, the requested video file is retrieved from one or more data servers 120₁, . . . , and/or 120_{M}.

At data center 100, the video file is stored as a compressed video file in a selected resolution in lieu of being stored multiple times, each in different formats and/or with different resolutions. Thereafter, user-targeted data processing system 110 matches video frames forming the video file requested by client device 130₁ and decompresses and/or decodes the video frames. This places the video in a decoded, decompressed (raw) format. One or more advertisements targeted for the user are integrated within the video, and thereafter, the video combined with the advertisements is re-compressed for transmission to client device 130₁.

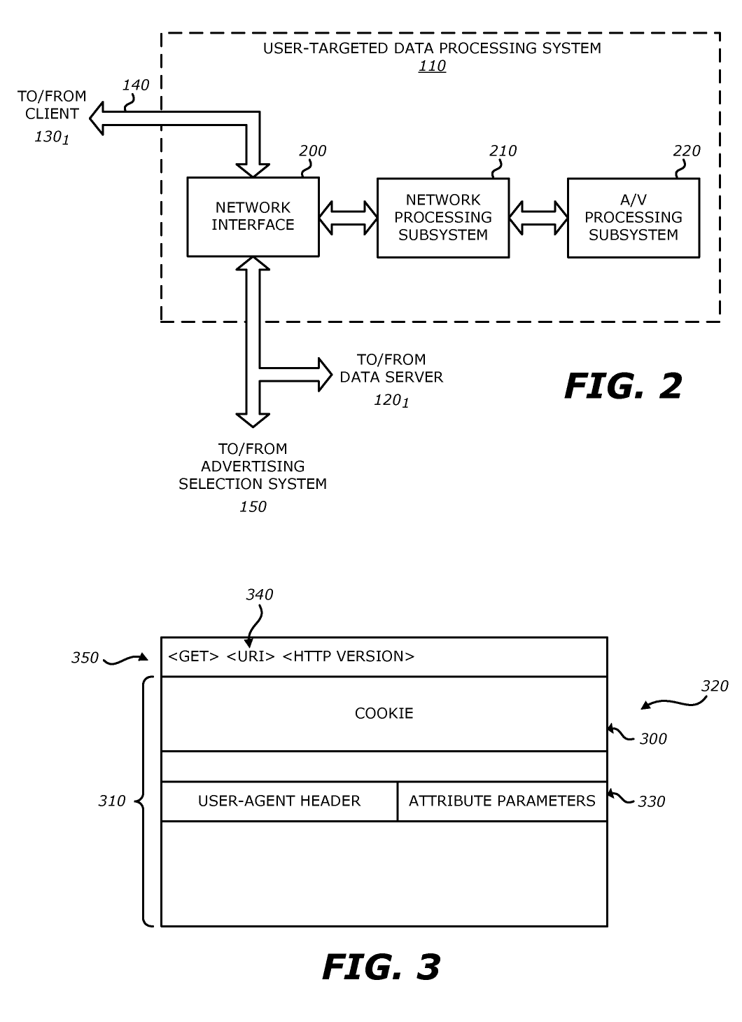

Referring to FIG. 2, an exemplary embodiment of user-targeted data processing system 110 that alters downloaded content requested by a client device through insertion of targeted advertisements is shown. User-targeted data processing system 110 comprises a network interface 200, a network processing subsystem 210 and an A/V processing subsystem 220. Herein, network interface 200 includes logic to determine the destination and source of messages routed over interconnect 140. For instance, as one illustrative embodiment of the invention, network interface 200 can be implemented as an Ethernet interface to detect ingress Ethernet frames (IP packets) sent to data center 100.

Network processing subsystem 210 receives IP packets from network interface 200 and processes them. More specifically, for ingress traffic uploaded to data center 100, network processing subsystem 210 receives these IP packets over interconnect 140 and scans them for either a HTTP (GET or POST) Request message or a RTSP (PLAY) Request message. This may be accomplished by conducting a text-based search of the Request message.

Upon detecting a Request message for downloaded content, network processing subsystem 210 extracts user-specific information within this message in order to determine the user initiating the request and forwards this information to advertisement-selection system 150. According to one embodiment of the invention, the user-specific information may be information supplied via an HTTP cookie (hereinafter referred to as a “Cookie”) as illustrated in FIG. 3 and described below.

As shown in FIG. 3, Cookie 300 is identified within a header 310 of an HTTP Request message 320. In general, Cookie 300 is a small text file that contains a string of alphanumeric characters and can be used to recall information as to what content has been previously downloaded by the user in order to develop a user profile and even user preferences.

For instance, Cookie 300 may inform advertisement-selection system 150 that a user has visited a particular web site, and thus, this single cookie can be used to track the user across hundreds of sites. With each site visited, advertisement-selection system 150 may learn more about each user while building its extensive user profile database.

As an option, Cookie 300 may be adapted to contain personal information of the user provided such information is made available to (i) data center 100, (ii) advertising-selection system 150 and/or (iii) a remote site that is in communication with these entities. The personal information may include one or more of the following: user name, zip code, demographic information (e.g., age, gender, martial status, financial status, etc.), interests, hobbies, visited web sites, and the like.

Based on receipt of Cookie 300 recovered from HTTP Request message 320 and the user profile or information derived therefrom, advertising-selection system 150 can coordinate the upload the advertisement (e.g., content as video, images, or audio) that is tailored to the user's likely interests as described below.

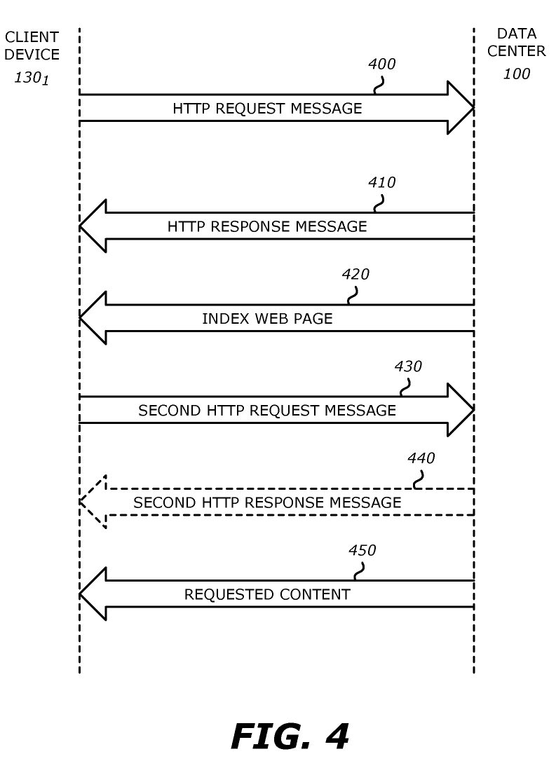

More specifically, referring now to FIG. 4, an illustrative embodiment of the communications between data center 100 and client device 130₁ requesting content from data center 100 is shown. Initially, an HTTP Request message 400 is transmitted as represented below in Table A. The name of each HTTP header is separated from its value by a single colon.

TABLE A

GET /video/index.html HTTP/1.1,
Accept: */*
Accept-Language: en
Accept-encoding: gzip, deflate
Connection: Keep-Alive
Host: www.pixel8networks.com
User-Agent: Safari 4.0; Resolution 480×320

Herein, HTTP Request message 400 may have a simple text based structure. The first line, known as the request line, contains (i) the HTTP method, GET; (ii) the relative URI of the resource (or a full URL if HTTP proxy is used); and (iii) the version of HTTP that is being used.

Herein, the User-Agent header is associated with values that supply user-targeted data processing system 110 of FIG. 2 with information pertaining to certain attribute parameters of the client device sending the Request message. Herein, as shown in Table A, the User-Agent header identifies that the client device features a Safari™ browser (version 4.0) and 480×320 display resolution.

According to another embodiment of the invention, referring back to FIG. 3, attributes of the client device may be placed within the URI 340 in the request line 350 of HTTP Request message 300. For instance, request line 350 may be represented in the following form as shown below in Table B:

TABLE B

GET/get_video?resolution=480×320&Device=iPhone&video=
index.html

The parameters in the URI can be opaque, in other words, the client would hash (e.g., using SHA-1 or another one-way hash function) the attributes so that malicious users could not send arbitrary attributes in an attempt to crash the service. The URI would look be represented as shown in Table C:

TABLE C
GET/get_video?attributes=46578ABDE858409854&video=animals.flv

Once the attributes are determined, user-targeted data processing system 110 can return an HTTP Response message 410 to client device 130₁ as shown in FIG. 4. More specifically, user-targeted data processing system 110 replies by sending the requested index web page 420 preceded by a packet of text, referred to as a “HTTP Response.” This message may contain lines requesting the browser to store cookies as shown below in Table D.

TABLE D

```
  HTTP/1.1 200 OK
  Content-type: text/html
  Set-Cookie: <name>=<value>; expires=<date>;
path =</>; domain = <.pixel8networks.com>,
      where “<>” denotes values to be set.
```

The line “Set-cookie” is placed in HTTP Response message 410 if data center 100 wishes the browser in operation at client device 130₁ to store a cookie. More specifically, “Set-cookie” is a request for the browser to store the string “value” identified by “name” <name>=<value> and send that named cookie back in all future requests to data center 100. If the browser at client device 130₁ supports cookies and cookies are enabled, every subsequent page request to data center 100 should contain the cookie.

Beside the name/value pair, a cookie may also contain an expiration date, a path, a domain name, and whether the cookie is intended only for encrypted connections. This data follows the name/value pair and is separated by semicolons as shown above.

The domain and path strings provide data to the browser that the cookie has to be sent back to the server when requesting URIs of a given domain and path. If not specified, according to one embodiment of the invention, these elements default to the domain and path of the object that was requested.

The expiration date tells the browser located on the client device when to delete the cookie. If no expiration date is provided, the cookie is deleted at the end of the user session, that is, when the user quits the browser. As a result, specifying an expiration date is a mechanism for allowing cookies to be persistent (i.e., survive multiple browser sessions). The expiration date is specified by weekday, calendar date and time (hour:minute:second).

For example, if the <name> is selected as “NETw” and the string is set at “62534sadfg40594,” the browser may request a flash video http://www.pixel8network.com/dogs.flv by sending data center 100 with a second HTTP Request message 430 as set forth in Table E.

TABLE E

GET /video/dogs.flv HTTP/1.1,
Accept: */*
Accept-Language: en
Accept-encoding: gzip, deflate
Connection: Keep-Alive
Host: www.pixel8networks.com
Cookie: NETw=62534sadfg40594;
User-Agent: Safari 4.0; Resolution 480×320

Herein, second HTTP Request message 430 differs from HTTP Request message 400 because it contains a string “62534sadfg40594” that the data center has previously sent to the browser. This way, data center 100 knows that this request is related to the previous one. A data server within data center 100 answers by sending the requested flash video 450, possibly adding another cookie as well by including a new “Set-Cookie: NETw=<newvalue> line within a second HTTP Response message 440.

Referring back to FIG. 2, for egress traffic detected by network interface 200, network processing subsystem 210 scans for the particular content (e.g., video), and parses the video into video frames. The video frames are sent to A/V processing subsystem 220 where compressed video frames or images are decompressed and/or decoded, perhaps reliance on one or more prior video frames to decompress a single subsequent frame. A/V processing subsystem 220 may be implemented with one or more graphic processor units (GPUs) to process the incoming content.

As A/V processing subsystem 220 receives the advertisement from advertising-selection system 150, such advertisements are placed in a raw (decompressed/decoded) format as well. These advertisements are now inserted into one or more video frames currently in raw format before these video frame(s) is(are) compressed (and/or encoded) prior to transmission to the requesting client device.

Network processing subsystem 210 then encapsulates the video into IP packets (Ethernet frames) and forwards them to the client device.

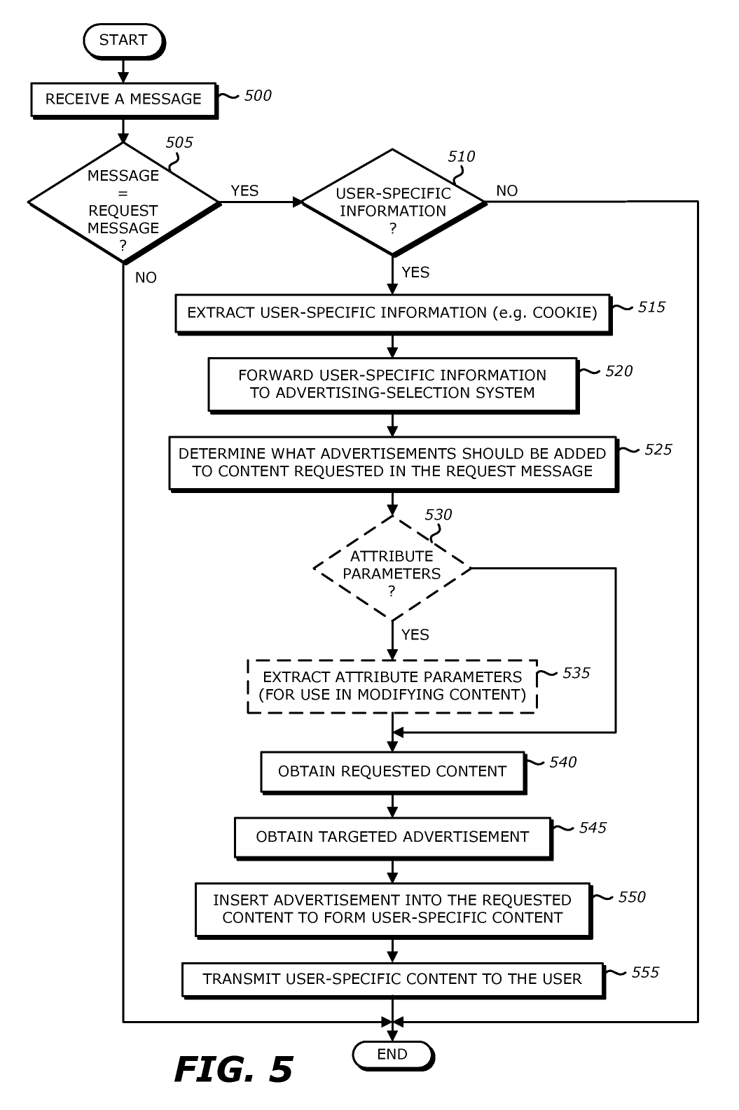

Referring to FIG. 5, an exemplary embodiment of a flowchart that outlines operations performed by user-targeted data processing system 110 of FIG. 2 to integrate user-specific information into requested content and subsequently store attribute parameters of a client device for such integration is shown. Herein, the user-targeted data processing system receives a message and determines if the message is a Request message for content such as an HTTP GET Request for example (blocks 500 and 505). If so, a determination is made whether the Request message features user-specific information pertaining to the user of the client device initiating the Request message (block 510).

Upon determining that the Request message includes the user-specific information, the user-targeted data processing system parses through the Request message to extract this information (block 515). According to one embodiment of the invention, the user-specific information is a cookie that is identified within a header of the Request message. The cookie is forwarded to an advertising-selection system and is used to determine what advertisement(s), if any, should be added to the content (blocks 520 and 525).

As an optional feature, a further determination may be made by the user-targeted data processing system to determine whether the Request message features attribute parameters for the client device initiating the Request message (block 530). Upon determining that the Request message includes the client device's attribute parameters, the user-targeted data processing system parses through the Request message to extract these parameters (block 535). The attribute parameters may include, but are not limited or restricted to one or more of the following: format of the content such as flash “flv”, Windows® Media Video “wmv”, MP4 or the like; display resolution such as 480×320, 1080p (1920×1080 progressive), 1080i (1920×1080 interlaced), 640×480, or the like; browser type such as Internet Explorer®, Mozilla™, Chrome™ or the like; compression type such as H.264, H.263, H.261, MPEG-2, Theora, Sorenson, VC-1, VP6 or the like. Of course, it is contemplated that one or more of these attribute parameters for the client device or other attribute parameters may be placed within the Request message.

The Request message is forwarded or another message is formulated and sent to obtain the requested content from one or more of the data servers (block 540). Also, the advertisement(s) determined by the advertisement-selection system is(are) provided to logic within the user-targeted data processing system that is responsible for processing the downloaded content before transmission to the client device (block 545). Thereafter, both the content and advertisement(s) are decoded and/or decompressed, as needed, and the advertisement(s) is(are) inserted within the content (block 550). This may involve the advertisement(s) being overlaid onto decoded and decompressed video frames forming the content.

Thereafter, the user-specific content is formatted (compressed and/or encoded) before being transmitted over a network to the requesting client device (block 555). This formatting may be in conducted in accordance with attribute parameters if such parameters are maintained by the user-targeted data processing system.

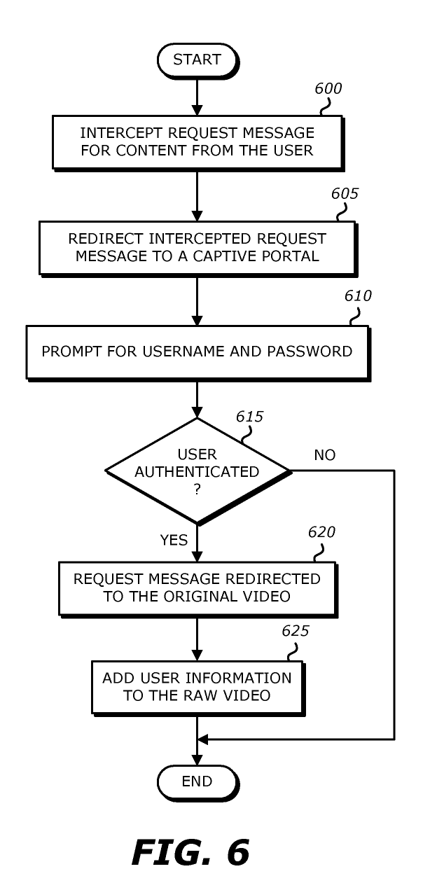

Referring now to FIG. 6, an exemplary embodiment of a flowchart that outlines operations performed by the user-targeted data processing system of FIG. 2 to insert a watermark into the content in order to identify ownership of the content and to protect copyrighted information as needed. First, a Request message (e.g., HTTP or HTTPS request) for content from the user is intercepted and redirected to a captive portal (HTTP server) resident in or in communication with the data center (blocks 600 and 605). The system prompts the user for his/her username and password (block 610). Upon receipt, the username and password are authentication against a local database resident in the system or against an external authentication server (block 615).

Thereafter, the Request message (e.g. HTTP request) is then redirected to the original video, and as the video passes through the system, the system adds the user information (username etc.) to the raw video itself (blocks 620 and 625). Hence, the user information appears in a watermark that appears in each video frame. Of course, the user information can be invisible and disguised as random noise in the video.

While the invention has been described in terms of several embodiments, the invention should not be limited to only those embodiments described, but can be practiced with modification and alteration within the spirit and scope of the appended claims.

What is claimed is:

1. A method comprising:
receiving a message requesting content, the message includes information that provides information about a user requesting the content;
modifying the content by inserting user-targeted information directly within the content, the user-targeted information is retrieved using the information; and
transmitting the modified content to a device controlled by the user.

2. The method of claim 1, wherein the information includes a cookie.

3. The method of claim 2, wherein the cookie is part of the message being a Hypertext Transfer Protocol (HTTP) GET Request message.

4. The method of claim 3, wherein the content is a video file and the user-targeted information is inserted into a video portion forming the video file.

5. The method of claim 3, wherein the content is video and the user-targeted information is inserted into payloads of video frames that collectively form the video.

6. The method of claim 1, wherein the user-targeted information is an advertisement.

7. The method of claim 6, wherein the advertisement is a video that is displayed as a trailer before the video is displayed on the device.

8. The method of claim 7, wherein the device is a cellular telephone with wireless networking capability.

9. The method of claim 1, wherein the content is modified by inserting user-targeted information directly within the content and formatted in accordance with attribute parameters provided in the message, the attribute parameters being values that identify specific characteristics of the device that initiated the message.

10. The method of claim 9, wherein the attribute parameters identify a display resolution of the device.

11. A system comprising:
at least one data server to store content; and
an user-targeted data processing system in communication with the at least one data server, the user-targeted data processing system includes
a network interface including logic to determine a destination of an incoming message,
a first processing subsystem to scan the incoming message to determine whether the incoming message is a Request message for a download of the content, and
a second processing subsystem to extract user-specific information within the Request message, the user-specific information includes a cookie that identifies prior websites visited by a source initiating the Request message, the second processing subsystem further to modify the content being downloaded by integrating user-targeted information with the content in order to produce a user-specific content.

12. The system of claim 11, wherein the second processing subsystem to modify the content to be downloaded by integrating an advertisement within a video to form the user-specific content.

13. The system of claim 12, wherein the second processing subsystem to modify the content to be downloaded according to at least one attribute parameter also provided within the Request message, the at least one attribute parameter being a value that identifies specific characteristics of a device that initiated the Request message and is intended to receive the user-specific content.

14. The system of claim 11, wherein the Request message is a Hypertext Transfer Protocol (HTTP) GET Request message that includes a header containing the user-specific information being a cookie.

15. Software implemented within a device and stored within internal memory located within the device, the software being executed by a processor and comprising:
logic for detecting a message requesting content, the message includes information that provides information about a user requesting the content;
logic for modifying the content by inserting user-targeted information directly within the content, the user-targeted information is retrieved using the information; and
logic for transmitting the modified content to a device controlled by the user.
